(19) United States
(12) Patent Application Publication
(10) Pub. No.: US 2026/0261953 A1
(43) Pub. Date: Sep. 3, 2026

(54) COMMUNICATION FOR U2U RELAY

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/846,885

(22) PCT Filed: Mar. 15, 2022
(86) PCT No.: PCT/CN2022/080922

§ 371 Date: Sep. 13, 2024

(51) Int. Cl. H04W 40/22; H04W 72/25; H04W 92/18

(52) U.S. Cl. CPC H04W 40/22; H04W 72/25; H04W 92/18

(57) ABSTRACT

Embodiments of the present disclosure relate to communication for U2U relay. A first device determines whether a message over a sidelink interface is allowed to be forwarded via a second device. If the message is allowed to be forwarded, the first device transmits the message to indicate that the message is allowed to be forwarded. The second device receives the message, and determines based on the message, whether the message is allowed to be forwarded via the second device. If the message is allowed to be forwarded, the second device forwards the message to a third device. The third device receives the message forwarded by the second device, and transmits a response to the message to indicate that the response is allowed to be forwarded via the second device. In this way, an E2E PC5-S message and a per-hop PC5-S message may be differentiated from each other.

### TECHNICAL FIELD

Embodiments of the present disclosure generally relate to the field of telecommunication, and in particular, to methods, devices and computer storage media of communication for user equipment (UE)-to-UE (U2U) relay.

### BACKGROUND

In U2U relay, UE (also referred to as source UE here) may communicate with another UE (also referred to as destination UE here) via still another UE (also referred to as relay UE here). A connection may be established between the source UE and the relay UE via a sidelink and also a connection may be established between the relay UE and the destination UE via a sidelink.

A message transferred between source UE and destination UE via relay UE is called as an end-to-end (E2E) PC5-signaling (PC5-S) message, and a message transferred between source UE and relay UE or between relay UE and destination UE is called as a per-hop PC5-S message. Both the E2E PC5-S message and the per-hop PC5-S message will be supported. In this case, how to differentiate the E2E PC5-S message from the per-hop PC5-S message needs to be further developed.

### SUMMARY

In general, embodiments of the present disclosure provide methods, devices and computer storage media of communication for U2U relay.

In a first aspect, there is provided a method of communication. The method comprises: determining, at a first device, whether a message over a sidelink interface is allowed to be forwarded via a second device; and in accordance with a determination that the message is allowed to be forwarded, transmitting the message to indicate that the message is allowed to be forwarded.

In a second aspect, there is provided a method of communication. The method comprises: receiving, at a second device and from a first device, a message over a sidelink interface; determining, based on the message, whether the message is allowed to be forwarded via the second device; and in accordance with a determination that the message is allowed to be forwarded, forwarding the message to a third device.

In a third aspect, there is provided a method of communication. The method comprises: receiving, at a third device, a message over a sidelink interface forwarded via a second device; and transmitting a response to the message to indicate that the response is allowed to be forwarded via the second device.

In a fourth aspect, there is provided a terminal device. The terminal device comprises a processor configured to perform the method according to any of the first to third aspects of the present disclosure.

In a fifth aspect, there is provided a computer readable medium having instructions stored thereon. The instructions, when executed on at least one processor, cause the at least one processor to perform the method according to any of the first to third aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure may be implemented;

FIG. 1B illustrates a schematic diagram of a control plane protocol stack for a sidelink control channel (SCCH) for PC5-radio resource control (PC5-RRC) in which some embodiments of the present disclosure can be implemented;

FIG. 1C illustrates a schematic diagram of a control plane protocol stack for SCCH for PC5-S in which some embodiments of the present disclosure can be implemented;

FIG. 1D illustrates a schematic diagram illustrating a procedure of a PC5-S unicast link establishment in which some embodiments of the present disclosure can be implemented;

FIG. 1E illustrates a schematic diagram illustrating a procedure of a PC5-S unicast link release in which some embodiments of the present disclosure can be implemented;

FIG. 1F illustrates a schematic diagram illustrating a procedure of a PC5-S unicast link maintenance in which some embodiments of the present disclosure can be implemented;

FIG. 2A illustrates a schematic diagram of an E2E user plane protocol stack in which some embodiments of the present disclosure can be implemented;

FIG. 2B illustrates a schematic diagram of an E2E control plane protocol stack in which some embodiments of the present disclosure can be implemented;

FIG. 2C illustrates a schematic diagram illustrating a connection establishment procedure for U2U relay communication in which some embodiments of the present disclosure can be implemented;

FIG. 3 illustrates a schematic diagram illustrating a process of communication for U2U relay according to embodiments of the present disclosure;

FIG. 4 illustrates a flowchart for an example method of communication implemented at a first device in accordance with some embodiments of the present disclosure;

FIG. 5 illustrates a flowchart for an example method of communication implemented at a second device in accordance with some embodiments of the present disclosure;

FIG. 6 illustrates a flowchart for an example method of communication implemented at a third device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2(24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/ Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “PC5 connection” may be used interchangeably with PC5-RRC connection, PC5 unicast link, layer-2 link or layer-2 unicast link. The term “E2E” may be used interchangeably with U2U or peer UE. The term “relay UE” may be used interchangeably with UE-to-network relay UE, UE-to-network relay, U2U relay UE, U2U relay or relay device. The term “upper layer” may be used interchangeably with proximity based services or proximity-services (ProSe) layer, vehicle-to-everything (V2X) layer, non-access stratum (NAS) layer or PC5-S layer. The term “lower layer” may be used interchangeably with access stratum (AS) layer, radio resource control (RRC) layer, packet data convergence protocol (PDCP) layer, radio link control (RLC) layer, medium access control (MAC) layer, layer-2 or layer 2. The term “adaptation layer identity (ID) for UE” may be used interchangeably with UE ID in adaptation layer, path ID, link ID, or information identifying source UE in adaptation layer. The term “discovery message” may be used interchangeably with direct communication request message or direct link establishment request message. The term “source UE” may be used interchangeably with initiating UE or source device. The term “destination UE” may be used interchangeably with target UE or destination device. The term “a message over a sidelink interface” may be used interchangeably with PC5 signaling message or PC5-S message.

As mentioned above, both an E2E PC5-S message and a per-hop PC5-S message will be supported, but how to differentiate the E2E PC5-S message from the per-hop PC5-S message needs to be further developed.

Embodiments of the present disclosure provide a solution of communication for U2U relay. In the solution, a message over a sidelink interface is transmitted to indicate that the message is allowed to be forwarded. In this way, an E2E PC5-S message from a per-hop PC5-S message may be differentiated from each other, and communication efficiency may be improved.

Principles and implementations of the present disclosure will be described in detail below with reference to the figures.

### Example of Communication Network

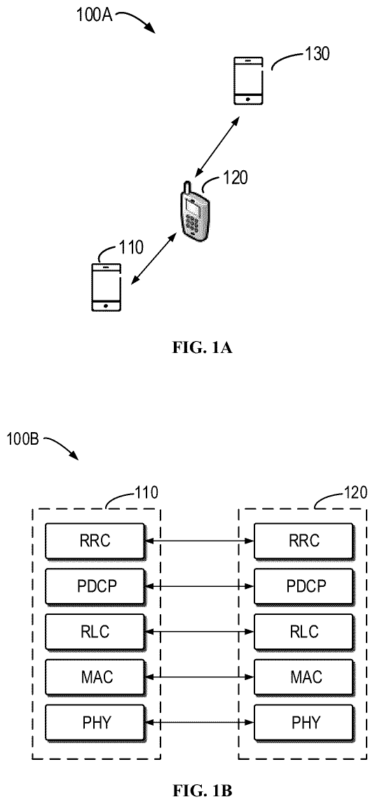

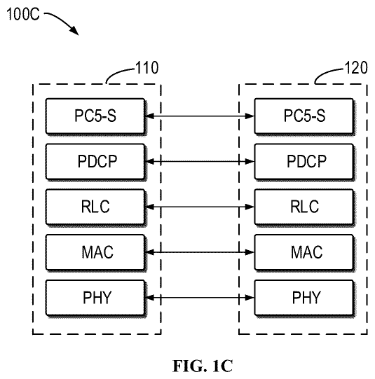

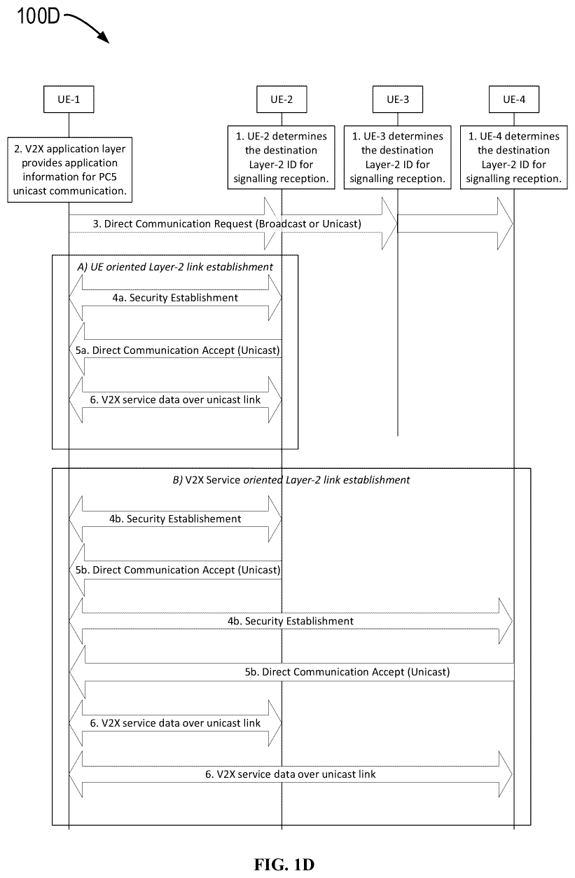

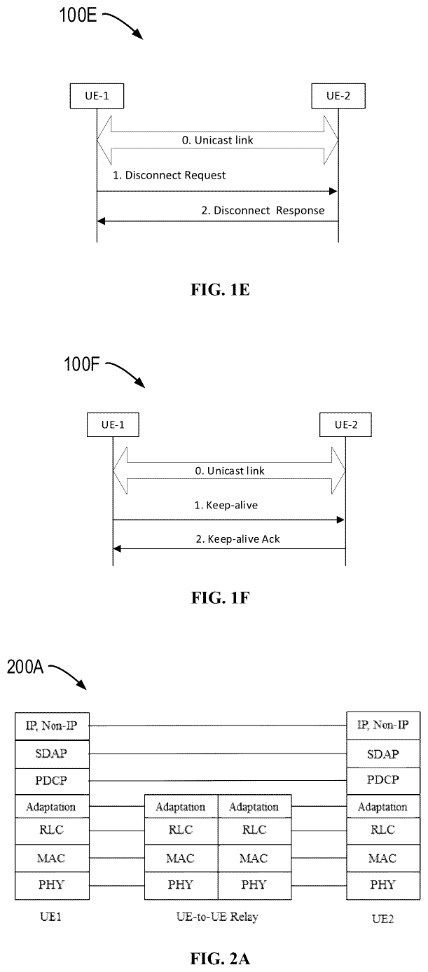

FIG. 1 illustrates a schematic diagram of an example communication network 100 in which some embodiments of the present disclosure can be implemented. As shown in FIG. 1, the communication network 100 may include a first device 110, a second device 120 and a third device 130. In the example of FIG. 1, the first device 110 may be connected with the second device 120 via a sidelink interface (for example, PC5 interface or the like), and also the third device 130 may be connected with the second device 120 via a sidelink interface. The first device 110 may communicate with the third device 130 via the second device 120.

In some embodiments, the first device 110 may transmit a message to the third device 130 via the second device 120. In this case, the first device 110 serves as a source device, the second device 120 serves as a relay device, and the third device 130 serves as a destination device. In some alternative embodiments, the third device 130 may transmit a message to the first device 110 via the second device 120. In this case, the third device 130 serves as a source device, the second device 120 serves as a relay device, and the first device 110 serves as a destination device. For convenience, the following description is given by taking a transmission from the first device 110 to the third device 130 as an example.

In some embodiments, the first device 110 and the second device 120 may communicate with each other via a sidelink channel such as a physical sidelink shared channel (PSSCH), a physical sidelink control channel (PSCCH), a physical sidelink feedback channel (PSFCH), a physical sidelink broadcast channel (PSBCH) or the like. For example, a PC5 link or PC5 RRC connection may be established between the first device 110 and the second device 120. The third device 130 and the second device 120 may communicate with each other in similar way as that for the first device 110 and the second device 120.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices in FIG. 1 is given for the purpose of illustration without suggesting any limitations to the present disclosure. The communication network 100 may include any suitable number of first devices, second devices or third devices adapted for implementing implementations of the present disclosure.

For illustration, the first device 110, the second device 120 and the third device 130 are shown as terminal devices. Merely for illustration purpose and without suggesting any limitations as to the scope of the present disclosure, some embodiments will be described in the context where the first device 110, the second device 120 and the third device 130 are terminal devices. It is to be understood that, in other embodiments, the first device 110 and/or the second device 120 and/or the third device 130 may be a network device. The present application does not limit this aspect.

The communications between terminal devices in the communication network 100 may be performed in accordance with control plane protocol stacks. FIG. 1B illustrates a schematic diagram 100B of a control plane protocol stack for a SCCH for PC5-RRC in which some embodiments of the present disclosure can be implemented. For illustration, the following description is given by taking the first device 110 and the second device 120 as examples of the terminal devices.

As shown in FIG. 1B, in the control plane, each of the first device 110 and the second device 120 may comprise an entity for Layer 1 (L1) layer, i.e., an entity for a physical layer (also referred to as a PHY layer or a PHY entity), and one or more entities for upper layers (Layer 2 (L2) and Layer 3 (L3) layers, or upper layers) including an entity for a MAC layer (also referred to as a MAC entity), an entity for a RLC layer (also referred to as a RLC entity), an entity for a PDCP layer (also referred to as a PDCP entity), and an entity for a RRC layer (also referred to as a RRC entity).

A sublayer (also referred to as a PC5-RRC layer) of the RRC layer may provide the following services and functions over a PC5 interface: transfer of a PC5-RRC message between peer UEs; maintenance and release of a PC5-RRC connection between two UEs; and detection of sidelink radio link failure for a PC5-RRC connection. A PC5-RRC connection is a logical connection between two UEs for a pair of Source and Destination Layer-2 IDs which is considered to be established after a corresponding PC5 unicast link is established. There is one-to-one correspondence between the PC5-RRC connection and the PC5 unicast link.

FIG. 1C illustrates a schematic diagram 100C illustrating a control plane protocol stack for SCCH for PC5-S in which some embodiments of the present disclosure can be implemented. As shown in FIG. 1C, in the control plane, each of the first device 110 and the second device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a PC5-S layer (also referred to as a PC5-S entity).

Generally, channels between the PC5-RRC layer and PDCP layer are called as sidelink radio bearers. A terminal device may be configured with at least one sidelink signaling radio bearer (SRB) for bearing control plane data. For each PC5-RRC connection of unicast, one sidelink SRB (i.e. SL-SRB0) is used to transmit the PC5-S message(s) before the PC5-S security has been established. One sidelink SRB (i.e. SL-SRB1) is used to transmit the PC5-S messages to establish the PC5-S security. One sidelink SRB (i.e. SL-SRB2) is used to transmit the PC5-S messages after the PC5-S security has been established, which is protected. One sidelink SRB (i.e. SL-SRB3) is used to transmit the PC5-RRC signaling, which is protected and only sent after the PC5-S security has been established.

FIG. 1D illustrates a schematic diagram 100D illustrating a procedure of a PC5-S unicast link establishment in which some embodiments of the present disclosure can be implemented. With reference to FIG. 1D, as shown in step 1, UE-2, UE-3 and UE-4 determine destination layer-2 ID for signaling reception respectively. As shown in step 2, UE-1 provides application information for PC5 unicast communication at V2X application layer.

As shown in step 3, UE-1 transmits a Direct Communication Request message in broadcast or unicast to initiate a unicast layer-2 link establishment procedure. The Direct Communication Request message may comprise source user information (i.e., UE-1's application layer ID), V2X service information about V2X service type(s) requesting layer-2 link establishment and security information for establishment of security.

Then, security with UE-1 is established. As shown in step 4a, if target user information (for example, UE-2's application layer ID) is comprised in the Direct Communication Request message, UE-2 responds by establishing the security with UE-1. As shown in step 4b, if target user information is not comprised in the Direct Communication Request message, UE (for example, UE-2 and UE-4) that is interested in using the announced V2X service type(s) over a PC5 unicast link with UE-1 responds by establishing the security with UE-1.

Then a Direct Communication Accept message is transmitted to UE-1 in unicast by UE that has successfully established the security with UE-1. As shown in step 5a, if target user information (for example, UE-2's application layer ID) is comprised in the Direct Communication Request message, UE-2 responds with a Direct Communication Accept message if the application layer ID for UE-2 matches. As shown in step 5b, if target user information is not comprised in the Direct Communication Request message, UE (for example, UE-2 and UE-4) that is interested in using the announced V2X service(s) responds to the request by sending a Direct Communication Accept message. The Direct Communication Accept message may comprise source user information (i.e., UE-2 or UE-4's application layer ID), quality of service (QOS) information about PC5 QOS flow(s) requested by UE-1.

FIG. 1E illustrates a schematic diagram 100E illustrating a procedure of a PC5-S unicast link release in which some embodiments of the present disclosure can be implemented. With reference to FIG. 1E, as shown in step 0, a PC5 unicast link is established between UE-1 and UE-2. As shown in step 1, UE-1 sends a Disconnect Request message to UE-2 to release the established PC5 unicast link. As shown in step 2, UE-2 sends a Disconnect Response message to UE-1.

For example, upon receiving an indication from an AS layer that a PC5-RRC connection was released due to radio link failure (RLF), a V2X layer in UE-1 locally releases the PC5 unicast link associated with this PC5-RRC connection. The AS layer uses PC5 Link Identifier to indicate to the V2X layer the PC5 unicast link whose PC5-RRC connection was released. In this case, the release of the PC5 unicast link is initiated by PC5-RRC layer.

As another example, when the PC5 unicast link has been released, the V2X layer of each UE for the PC5 unicast link informs the AS layer that the PC5 unicast link has been released. The V2X layer uses PC5 Link Identifier to indicate the released unicast link. In this case, the release of the PC5 unicast link is initiated by V2X layer.

FIG. 1F illustrates a schematic diagram 100F illustrating a procedure of a PC5-S unicast link maintenance in which some embodiments of the present disclosure can be implemented. With reference to FIG. 1F, as shown in step 0, a PC5 unicast link is established between UE-1 and UE-2. As shown in step 1, UE-1 sends a Keep-alive message to UE-2 to maintain the established PC5 unicast link. As shown in step 2, UE-2 sends a Keep-alive Acknowledgement message to UE-1. For example, the trigger for the Keep-alive message may be based on a timer associated with the PC5 unicast link.

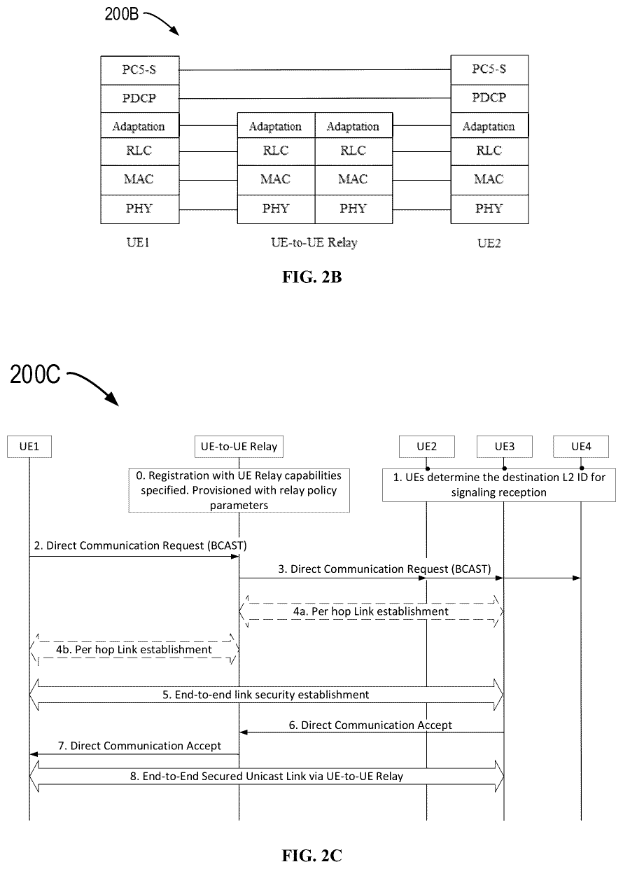

FIG. 2A illustrates a schematic diagram 200A of an E2E user plane protocol stack in which some embodiments of the present disclosure can be implemented. As shown in FIG. 2A, in E2E user plane, UE1 and UE2 may directly communicate with each other over PDCP layer, SDAP layer and IP/Non-IP layer. UE1 and UE2 may communicate with each other via a UE-to-UE Relay over adaptation layer, RLC layer, MAC layer and PHY layer.

FIG. 2B illustrates a schematic diagram 200B of an E2E control plane protocol stack in which some embodiments of the present disclosure can be implemented. As shown in FIG. 2B, in E2E control plane, UE1 and UE2 may directly communicate with each other over PDCP layer and PC5-S layer. UE1 and UE2 may communicate with each other via a UE-to-UE Relay over adaptation layer, RLC layer, MAC layer and PHY layer. The control plane protocol stack of a PC5 unicast link between UE1/UE2 and UE-to-UE Relay may re-use the PC5-S protocol stack as shown in FIG. 1C.

FIG. 2C illustrates a schematic diagram 200C illustrating a connection establishment procedure for U2U relay communication in which some embodiments of the present disclosure can be implemented. With reference to FIG. 2C, as shown in step 0, UE-to-UE Relay performs a registration with UE Relay capabilities specified and is provisioned with relay policy parameters. As shown in step 1, UE-2, UE-3 and UE-4 determine destination layer-2 ID for signaling reception respectively.

As shown in step 2, UE-1 transmits a Direct Communication Request message in broadcast (BCAST). For example, an application layer of UE-1 provides information (e.g., broadcast layer-2 ID, ProSe application layer ID, UE's application layer ID, target UE's application layer ID, relay applicable indication) to a ProSe layer for PC5 unicast communication. The ProSe layer triggers a peer UE discovery mechanism by sending an E2E broadcast Direct Communication Request message. The message is sent using a source Layer-2 ID and broadcast Layer-2 ID as destination, and includes other parameters related to the application offered.

As shown in step 3, the UE-to-UE Relay receives the broadcasted Direct Communication Request message and verifies if it's configured to relay this application, i.e. it compares the announced ProSe application ID with its provisioned relay policy/parameters. The UE-to-UE Relay forwards the E2E broadcast Direct Communication Request message by using its own layer-2 ID as source L2 ID and additionally including Relay UE's ID in the message. The UE-to-UE Relay also specifies information identifying UE1 in adaptation layer. The UE-to-UE Relay handles this E2E broadcast Direct Communication Request message in the ProSe layer, and forwards any subsequent E2E PC5-S message based on the specified information identifying UE1 in adaptation layer.

As shown in step 4A, UE3 is interested in the announced application, and triggers a per-hop link establishment with the UE-to-UE Relay if there is no existing per-hop link between the UE3 and the UE-to-UE Relay. As shown in step 4B, the UE-to-UE Relay triggers a per-hop link establishment with the UE1 if there is no existing per-hop link between the UE1 and the UE-to-UE Relay.

As shown in step 5, an end-to-end security establishment is performed between the UE1 and the UE3. As shown in step 6, the UE3 sends a Direct Communication Accept message to the UE-to-UE Relay. As shown in step 7, the UE-to-UE Relay forwards the Direct Communication Accept message to the UE1. As shown in step 8, an end-to-end secured unicast link via the UE-to-UE Relay is established between the UE1 and the UE3.

Return to FIG. 2B, an E2E PC5-S message is a message transferred between UE1 and UE2 via UE-to-UE Relay, and a per-hop PC5-S message is a message transferred between UE1 and UE-to-UE Relay or between UE-to-UE Relay and UE2.

In some scenarios for connection establishment, some discovery messages should be processed locally at relay UE while some other discovery messages need to be forwarded to other UEs. In this case, relay UE needs to determine which of the discovery messages should be forwarded.

In some scenarios for signaling forwarding, multiple PC5 unicast link may be mapped to the same PC5-RRC connection. For example, per-hop PC5 unicast link and E2E PC5 unicast link may be mapped to the same PC5-RRC connection. In another example, different E2E PC5 unicast links may be mapped to the same PC5-RRC connection. In this case, if the same PC5-RLC channel (i.e. PC5 RLC bearer) or the same sidelink SRB is user for both E2E PC5-S message and per-hop PC5-S message, the E2E PC5-S message will be sent to the PC5-S layer (e.g. V2X layer) of the relay UE and be interpreted by this relay UE. This may cause an E2E security issue for the E2E PC5-S message.

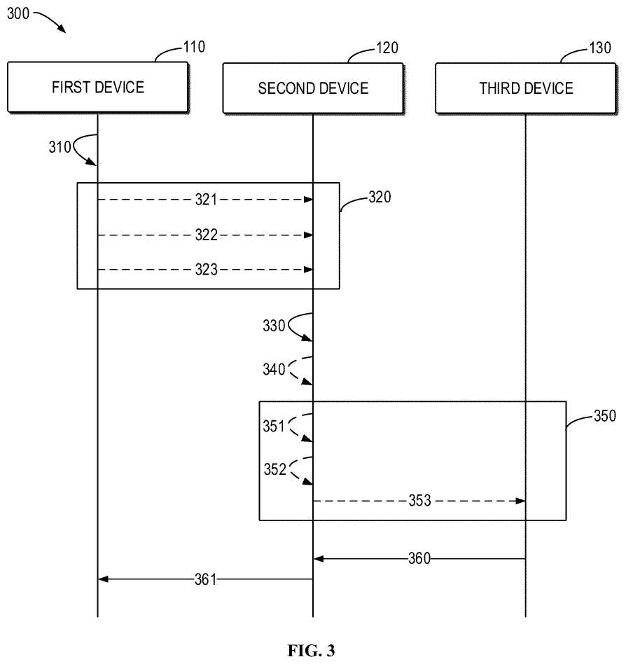

Embodiments of the present disclosure provide Embodiments of the present disclosure provide a solution for differentiating an E2E PC5-S message from a per-hop PC5-S message so as to solve the above or other potential issues. The detailed description will be made below with reference to FIG. 3.

### Example Implementation of Signaling Forwarding for U2U Relay

FIG. 3 illustrates a schematic diagram illustrating a process 300 of communication for U2U relay according to embodiments of the present disclosure. For the purpose of discussion, the process 300 will be described with reference to FIG. 1. The process 300 may involve the first device 110, the second device 120 and the third device 130 as illustrated in FIG. 1. The steps and the order of the steps in FIG. 3 are merely for illustration, and not for limitation. For example, the order of the steps may be changed. Some of the steps may be omitted or any other suitable additional steps may be added.

For convenience, the process 300 is described by taking a transmission from the first device 110 to the third device 130 as an example. It is to be understood that the same process may also be suitable for a transmission from the third device 130 to the first device 110. In this example, the first device 110 serves as a source device, the second device 120 serves as a relay device, and the third device 130 serves as a destination device.

### 1. Example Operation at Source Device

As shown in FIG. 3, the first device 110 determines 310 whether a message over a sidelink interface is allowed to be forwarded or relayed via the second device 120. In other words, the first device 110 may determine whether a message to be transferred is an E2E PC5-S message or a per-hop PC5-S message.

In some embodiments, the message may be a communication request message or communication request response message for connection establishment, for example, Direct Communication Request message or Direct Communication Accept message or any other suitable messages. In some embodiments, the message may be a message to be transferred after connection establishment, for example, PC5 signaling message or any other suitable messages. It is to be understood that the message may be in any suitable forms and the present disclosure does not limit this aspect.

If the message is allowed to be forwarded (e.g., the message is the E2E PC5-S message), the first device 110 transmits 320 the message to indicate that the message is allowed to be forwarded. It is to be understood that the indication may be carried out in any suitable ways.

### 1) Indication by Dedicated Resource

In this embodiment, the first device 110 may transmit 321 the message via a resource or resource pool configured or dedicated for indicating that the message is allowed to be forwarded.

In some embodiments, the resource or resource pool may be associated with at least one of the following: a sidelink SRB, a sidelink RLC channel, a logical channel (LCH), a broadcast layer 2 identifier, a sidelink-unlicensed resource pool, or a sidelink resource pool. In some embodiments, the resource or resource pool may be pre-defined (i.e. pre-defined by the 3GPP protocol/specification) or pre-configured. It is to be understood that the present disclosure does not limit this aspect.

In some embodiments, the first device 110 may transmit, from an upper layer (for example, V2X layer or ProSe layer) to a lower layer (for example, AS layer) of the first device 110, information (for convenience, also referred to as first information herein) indicating that the message is allowed to be forwarded. In other words, the upper layer may indicate the lower layer that the message is an E2E PC5-S message. Alternatively, the upper layer may indicate the lower layer that the message is an E2E PC5-S message or a per-hop PC5-S message. In response to receiving the first information from the upper layer, the lower layer of the first device 110 may determine the resource or resource pool and transmit the message via the resource or resource pool. In some embodiments, the first device 110 may transmit, from an upper layer to a lower layer of the first device 110, information (for convenience, also referred to as second information herein) indicating the resource or resource pool. In response to receiving the second information from the upper layer, the lower layer of the first device 110 may transmit the message via the resource or resource pool.

In some embodiments, the first device 110 may transmit the message over a sidelink SRB, e.g., SL-SRB5 or any other suitable sidelink SRBs existing (for example, SL-SRB0, SL-SRB1) or to be developed in future. A configuration for the sidelink SRB may comprise a PDCP configuration, a RLC configuration and a MAC configuration. For example, for sidelink SRB addition, if transmission or reception of message over a sidelink interface (for example, E2E broadcast Direct Communication Request message) for a specific destination is requested by upper layers for sidelink SRB: establish PDCP entity, RLC entity and the logical channel of a sidelink SRB5 for discovery message. For sidelink SRB release, if transmission or reception of message over a sidelink interface (for example, E2E broadcast Direct Communication Request) for a specific destination is terminated in upper layers: release the PDCP entity, RLC entity and the logical channel of the sidelink SRB5 for discovery message of the specific destination.

In some embodiments, the first device 110 may transmit the message over a sidelink RLC channel, e.g., SL-RLC2 or any other suitable sidelink RLC channels existing or to be developed in future. A configuration for the sidelink RLC may comprise a RLC configuration and a MAC configuration. For example, for RLC entity establishment, For NR sidelink groupcast and broadcast, when receiving the first UMD PDU from a Source Layer 2 ID and Destination Layer 2 ID pair for an LCID, and there is not yet a corresponding receiving RLC entity for a radio bearer, the UE shall: establish a receiving RLC entity; set the state variables of the RLC entity to initial values; follow the legacy procedures. For RLC entity release, When upper layers request an RLC entity release, the UE shall: discard all RLC SDUs, RLC SDU segments, and RLC PDUs, if any; release the RLC entity. For groupcast and broadcast of NR sidelink communication or a message over a sidelink interface, the receiving UM RLC entity release is up to UE implementation.

In some embodiments, the resource or resource pool may use default or fixed configuration. For example, the resource or resource pool may be configured via system information for in-coverage UE. As another example, the resource or resource pool may be pre-defined or pre-configured. For example, the resource or resource pool may be pre-defined for out-of-coverage UE.

In some embodiments, a system information block (SIB) may be used to configure the resource or resource pool. The SIB may be any suitable SIBs existing or to be developed in future. For example, SIB12 may be reused for configuring the resource or resource pool for U2U relay. In some embodiments, only UE supporting U2U relay needs to request or read the SIB.

### 2) Indication in Message

In this embodiment, the first device 110 may transmit 322 the message comprising an indication, the indication indicating that the message is allowed to be forwarded.

In some embodiments, the indication may be a bit value. For example, the bit value may be 1 or any other suitable values. In some embodiments, the indication may indicate the maximum number of hops allowed for forwarding of the message. In this case, the indication may have a value greater than 0. The value of the indication may be decremented by 1 before the forwarding of the message. In some embodiments, the presence of the indication may indicate that the message is allowed to be forwarded and the absence of the indication may indicate that the message is not allowed to be forwarded. It is to be understood that the indication comprised in the message may also adopt any other suitable forms.

### 3) Indication Via Adaptation Layer

In this embodiment, the first device 110 may transmit 323 the message via an adaptation layer of the first device 110.

In some embodiments, the first device 110 may transmit, from an upper layer (for example, V2X layer or ProSe layer) to a lower layer (for example, AS layer) of the first device 110, information indicating an identity (ID) of a link between the first device 110 and the third device 130. In some embodiments, the ID of the link may be a PC5 link ID, or a destination UE ID (for example, 24bits), or a source UE ID, or a pair of source UE ID and destination UE ID. For example, both the source UE ID and the destination UE ID are layer 2 identifiers, which are comprised in the sidelink control information (SCI) for the sidelink transmission.

In some embodiments, the ID of the link may be a temporary PC5 link ID which has integer number of bits (for example, 5 bits). And the number of bits for the temporary PC5 link ID may be smaller than that for the PC5 link ID. The temporary PC5 link ID may be mapped to the PC5 link ID or the destination UE ID. The temporary PC5 link ID may be used by the source device and relay device for data routing and may be not used as the destination for per-hop transmission. In some embodiments, the temporary PC5 link ID may be allocated by the fist device 110 or the second device 120, or the third device 130. In some embodiments, the temporary PC5 link ID may be pre-configured. With the temporary PC5 link ID, a signaling overhead may be saved.

Based on the information indicating the ID of the link, the lower layer may transmit the message via a sidelink SRB over an adaptation layer. In other words, the upper layer may indicate the lower layer to transmit the message via a sidelink SRB over an adaptation layer or transmit the message via a sidelink SRB without an adaptation layer. In response to receiving the information indicating the ID of the link, the first device 110 may use a sidelink SRB over an adaptation layer to send an E2E PC5-S message. The sidelink SRB over an adaptation layer may be an existing sidelink SRB or a sidelink SRB to be developed in future. In some embodiments, the first device 110 may transmit a per-hop PC5-S message via SL-SRB0, SL-SRB1 or SL-SRB2, and transmit an E2E PC5-S message via SL-SRB0, SL-SRB1 or SL-SRB2 over an adaptation layer. The sidelink SRB over an adaptation layer may refer to a sidelink SRB with a configuration of an adaptation layer. In some embodiments, a configured for the sidelink SRB may comprise a SRB ID, a PDCP configuration, and adaptation layer configuration. Of course, any other suitable forms are also feasible.

In some embodiments, the lower layer (for example, adaptation layer) may determine an egress link (e.g., the next hop relay UE or the destination layer 2 identifier for the sidelink transmission) based on the ID of the link (the PC5 link ID or destination UE ID or the temporary PC5 link ID), and transmit the message over the egress link. For example, the lower layer may determine a destination identifier (for example, layer 2 destination identifier) for the sidelink transmission based on the ID of the link rather than using a destination UE ID (for example, layer 2 destination identifier) indicated by the upper layer directly.

In some embodiments, the lower layer may determine an egress sidelink RLC channel based on the ID of the link (the PC5 link ID or destination UE ID or the temporary PC5 link ID) and sidelink SRB ID, and transmit the message over the egress sidelink RLC channel.

In some embodiments, the lower layer of the first device 110 may transmit a per-hop PC5-S message via SL-SRB0, SL-SRB1 or SL-SRB2, and transmit an E2E PC5-S message via a new sidelink SRB (for example, SL-SRB6) over an adaptation layer. For example, a plurality of new sidelink SRBs for different destination UEs or for different PC5 links. In other words, different destination UEs or for different PC5 links can be determined based on the plurality of new sidelink SRBs. In some embodiments, the first device 110 may transmit, from an upper layer (for example, V2X layer or ProSe layer) to a lower layer (for example, AS layer) of the first device 110, information indicating the new sidelink SRB. In some alternative embodiments, the new sidelink SRB may be determined based on the information indicating the ID of the link.

In some embodiments, the lower layer may determine an egress link (e.g., the next hop relay UE) based on the new sidelink SRB, and transmit the message over the egress link. In this case, separate sidelink SRBs are provided for different destination UEs or PC5 links. Thus a mapping procedure is simplified.

In some embodiments, the lower layer may determine an egress sidelink RLC channel based on the ID of the link (the PC5 link ID or destination UE ID or the temporary PC5 link ID) and sidelink SRB ID, and transmit the message over the egress sidelink RLC channel. In some embodiments, the lower layer may determine an egress sidelink RLC channel based on the new sidelink SRB. In this case, separate sidelink SRBs are also provided for different destination UEs or PC5 links. Thus a mapping procedure is simplified.

In some embodiments, a configured for the adaptation layer may comprise a mapping table, a RLC configuration and a MAC configuration. In some embodiments, to send an E2E PC5-S message, an adaptation layer ID for a destination device (i.e., the third device 130) and radio bearer ID (e.g., ID of sidlink SRB) may be added into a header of adaptation protocol data unit (PDU). For example, the adaptation layer ID may be determined based on the ID of the link indicated by the upper layer. In other words, the temporary PC5 link ID may be used as the adaptation layer ID. As another example, the adaptation layer ID may be determined based on a new sidelink SRB. In other words, the ID of the new sidelink SRB may be used as the adaptation layer ID.

### 2. Example Operation at Relay Device

With reference to FIG. 3, upon reception of the message from the first device 110, the second device 120 determines 330 whether the message is allowed to be forwarded via the second device 120. In other words, the second device 120 may determine whether the message is an E2E PC5-S message or a per-hop PC5-S message.

### 1) Determination of Forwarding

In some embodiments, if the message is received via a resource or resource pool configured or dedicated for indicating that the message is allowed to be forwarded, the second device 120 may determine that the message is allowed to be forwarded. In some embodiments, the resource or resource pool may be associated with at least one of the following: a sidelink SRB, a sidelink RLC channel, a logical channel (LCH), or a broadcast layer 2 identifier.

In some embodiments, the second device 120 may transmit, from a lower layer to an upper layer of the second device 120, information (for convenience, also referred to as third information herein) indicating that the message is allowed to be forwarded. In other words, the third information may indicate the message is E2E PC5-S message. Alternatively, the third information may indicate the message is E2E PC5-S message or per-hop PC5-S message. In some embodiments, the second device 120 may transmit, from a lower layer to an upper layer of the second device 120, information (for convenience, also referred to as fourth information herein) indicating the resource or resource pool. Based on the third or fourth information, the upper layer of the second device 120 may determine that the message is allowed to be forwarded.

In some embodiments, if the message comprises an indication indicating that the message is allowed to be forwarded, the second device 120 may determine that the message is allowed to be forwarded. In some embodiments, the second device 120 may indicate, from a lower layer to an upper layer of the second device 120, that the message is an E2E PC5-S message. In some embodiments, the second device 120 may indicate, from a lower layer to an upper layer of the second device 120, that the message is received via the resource or resource pool. The upper layer of the second device 120 may determine that the message is allowed to be forwarded.

In some embodiments, if an adaptation layer ID in an adapation layer PDU from the first device is different from an adaptation layer ID of the second device 120, the second device 120 may determine that the message is allowed to be forwarded. For example, if UE ID information in a header of adaptation layer PDU is not the adaptation layer ID of the second device 120, the second device 120 may determine that the message is allowed to be forwarded. In some embodiments, if an identity of an adaptation layer in the adaptation layer PDU matches with an entry of a mapping table stored by the second device 120, the second device 120 may determine that the message is allowed to be forwarded. The mapping table is configured for signaling and data forwarding. For example, the mapping table may comprise a correspondence between an adaptation layer ID and an egress link and an egress RLC channel. It is to be understood that the mapping table may adopt any other suitable forms.

### 2) Signaling Forwarding

Still with reference to FIG. 3, upon determination that the message is allowed to be forwarded, the second device 120 forwards 350 the message to the third device 130.

In some embodiments, if the message is allowed to be forwarded, the second device 120 may determine 340 whether the message is to be forwarded. If the message is to be forwarded, the second device 120 may forward the message. In some embodiments, if the message comprises information of the third device 130 and the third device 130 can be reached by the second device 120, the second device 120 may determine that the message is to be forwarded. For example, the third device 130 can be reached by the second device 120 means that a link between the second device 120 and the third device 130 has been established, the second device 120 may determine that the message is to be forwarded. As another example, the third device 130 can be reached by the second device 120 means that the second device 120 has received a message such as a discovery message from the third device 130. In some embodiments, if the second device supports a type of a service comprised in the message, the second device 120 may determine that the message is to be forwarded. In this way, efficient signaling forwarding may be facilitated. It is to be understood that the determination 340 is optional but is not necessary.
Forwarding Without Adaptation Layer

In some embodiments for forwarding the message without an adaptation layer, the second device 120 may modify 351 the message by the upper layer of the second device 120. For example, the message may be processed (e.g., modified or amended) and forwarded by the upper layer. In some embodiments, the second device 120 may determine whether the second device 120 is the first relay device (i.e., the first-hop relay device in multi-hop). In some embodiments, if the ID of the relay device is comprised in the message, the second device 120 may determine that the second device 120 is not the first relay device. In some embodiments, if a value of a counter comprised in the message is smaller than a predetermined value, the second device 120 may determine that the second device 120 is not the first relay device. In other words, a counter is introduced in an E2E PC5-S message. A value of the counter may be initially set to 0 at a source device and each relay device may increment the value of the counter by 1. It is to be understood that this is merely an example, and the value of the counter may be set in any other suitable ways.

In some embodiments, if the second device is the first relay device, the second device 120 may modify the message by adding, as an identity of a relay device, an ID of the second device 120 in the message. In some embodiments, if the second device is not the first relay device, the second device 120 may replace, with an ID of the second device 120, an identity of relay device in the message. In some embodiments, if the second device is not the first relay device, the second device 120 may add an ID of the second device 120 in a list of identities of delay devices in the message.

In some embodiments, the second device 120 may update 352, with an identity of the first device 110, an ID of a source device in an adaptation layer of the second device 120. In some embodiments, the second device 120 may update the ID of the source device by reusing the ID of the source device in the adaptation layer of the second device 120. In some embodiments, the second device 120 may update the ID of the source device by replacing the ID of the source device with an ID allocated by the second device 120. In some embodiments, the second device 120 may update the ID of the source device by adding an ID allocated by the second device 120 for the adaptation layer.

In some embodiments where the message comprises an indication indicating that the message is allowed to be forwarded and the indication has a value greater than 0, the second device 120 may further modify the message by decreasing the value of the indication.

Upon the modification of the message, the second device 120 may transmit 353 the modified message to the third device 130. In some embodiments, the second device 120 may transmit the modified message via the resource or resource pool. In some embodiments, the second device 120 may transmit the modified message via a further resource or resource pool configured for indicating that the message is allowed to be forwarded.

For example, in some embodiments, the second device 120 may transmit, from an upper layer (for example, V2X layer or ProSe layer) to a lower layer (for example, AS layer) of the second device 110, information indicating that the modified message is allowed to be forwarded. In other words, the upper layer indicates the lower layer that the modified message is an E2E PC5-S message. Alternatively, the upper layer indicates the lower layer that the modified message is E2E PC5-S message or a per-hop PC5-S message. In response to receiving the information from the upper layer, the lower layer of the second device 120 may determine the resource or resource pool or the further resource or resource pool, and transmit the modified message via the resource or resource pool or the further resource or resource pool.

In some embodiments, the second device 120 may transmit, from an upper layer to a lower layer of the second device 120, information indicating the resource or resource pool or the further resource or resource pool. In response to receiving the information from the upper layer, the lower layer of the the second device 120 may transmit the modified message via the resource or resource pool or the further resource or resource pool.
Forwarding With Adaptation Layer

In some embodiments for forwarding the message with an adaptation layer, the lower layer of the second device 120 may determine an egress link based on an ID of an adaptation layer in an adaptation layer PDU (for example, in a header of the adaptation layer PDU) or based on a sidelink SRB (for example, an ID of a sidelink SRB in the adaptation layer PDU), and forward the message via the egress link.

In some embodiments, the lower layer of the second device 120 may determine an egress sidelink RLC channel based on the sidelink SRB. In some alternative embodiments, the lower layer (for example, the adaptation layer) of the second device 120 may determine an egress sidelink RLC channel based on the sidelink SRB and the ID of the adaptation layer. The lower layer of the second device 120 may forward the message via the egress sidelink RLC channel.

### 3. Example Operation at Destination Device

Continue to refer to FIG. 3, upon reception of the message from the second device 120, the third device 130 transmits 360 a response to the message to indicate that the response is allowed to be forwarded via the second device 120.

In some embodiments, the third device 130 may transmit, from a lower layer to an upper layer of the third device 130, information (for convenience, also referred to as fifth information herein) indicating that the message is allowed to be forwarded. In some embodiments, the third device 130 may transmit, from a lower layer to an upper layer of the third device 130, information (for convenience, also referred to as sixth information herein) indicating a resource or resource pool, the resource or resource pool being configured for indicating that the message is allowed to be forwarded. In some alternative embodiments, the third device 130 may transmit, from a lower layer to an upper layer of the third device 130, information (for convenience, also referred to as XXXX information herein) indicating the message is an E2E PC5-S message. Alternatively, the lower layer may indicate the upper layer that the message is an E2E PC5-S message or a per-hop PC5-S message. In some embodiments, the upper layer of the third device 130 may transmit, to the lower layer of the third device 130, information (for convenience, also referred to as seventh information herein) indicating that the response is allowed to be forwarded. In some embodiments, the upper layer of the third device 130 may transmit, to the lower layer of the third device 130, information (for convenience, also referred to as eighth information herein) indicating the resource or resource pool. Then the lower layer of the third device 130 may transmit the response via the resource or resource pool. In this way, the third device 130 sends a response message along the same resource or resource pool.

In some embodiments, the third device 130 may transmit, from a lower layer to an upper layer of the third device 130, information (for convenience, also referred to as ninth information herein) indicating that the message is transmitted or received via an adaptation layer or indicating an ID of a link between the first device 110 and the third device 130. In some embodiments, the upper layer of the third device 130 may transmit, to the lower layer of the third device 130, information (for convenience, also referred to as tenth information herein) indicating that the response is transmitted via an adaptation layer of the third device 130 or indicating the ID of the link between the first device 110 and the third device 130. Then the lower layer of the third device 130 may transmit the response via the adaptation layer of the third device 130. In some embodiments, the lower layer of the third device 130 may determine an egress link or an egress RLC channel based on the tenth information and transmit the response via the egress link or the egress RLC channel.

For example, if UE ID information in a header of adaptation layer PDU is the adaptation layer ID of Destination UE (the third device 130), adaptation layer of this UE derives a service data unit (SDU) from the received adaptation layer PDU and forwards the SDU to upper layer (i.e. PDCP layer). Optionally, the PDCP layer send an indication about a sidelink SRB for the message along with this message to ProSec layer to differentiate the message from other per-hop PC5-S messages.

Upon reception of the response from the third device 130, the second device 120 forwards 361 the response to the first device 110. So far, signaling forwarding for U2U relay is achieved.

### Example Implementation of Methods

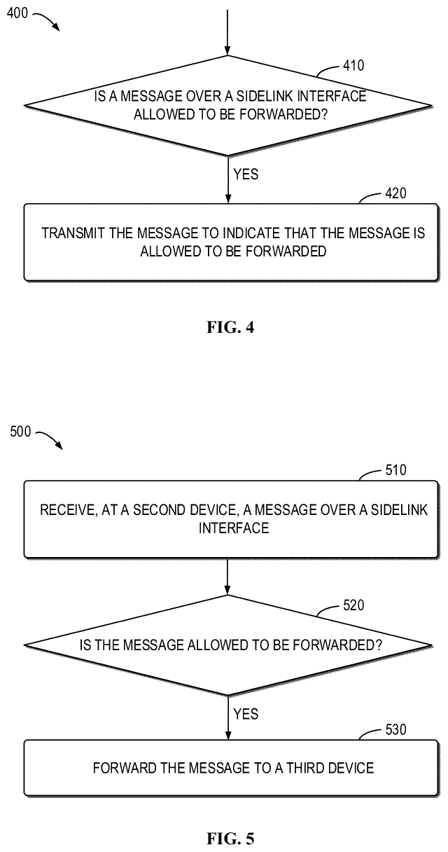

Accordingly, embodiments of the present disclosure provide methods of communication implemented at a source device, a relay device and a destination device. These methods will be described below with reference to FIGS. 4 to 6.

FIG. 4 illustrates an example method 400 of communication implemented at a first device as a source device in accordance with some embodiments of the present disclosure. For example, the method 400 may be performed at the first device 110 or the third device 130 as shown in FIG. 1. For the purpose of discussion, in the following, the method 400 will be described with reference FIG. 1 and by taking the first device 110 as an example. It is to be understood that the method 400 may include additional blocks not shown and/or may omit some blocks as shown, and the scope of the present disclosure is not limited in this regard.

At block 410, the first device 110 determines whether a message over a sidelink interface is allowed to be forwarded via the second device 120. If the message is allowed to be forwarded, the method 400 proceeds to block 420.

At block 420, the first device 110 transmits the message to indicate that the message is allowed to be forwarded.

In some embodiments, the first device 110 may transmit the message via a resource or resource pool configured for indicating that the message is allowed to be forwarded. In some embodiments, the resource or resource pool may be associated with at least one of the following: a sidelink SRB, a sidelink RLC channel, a LCH, or a broadcast layer 2 identifier. In some embodiments, the first device 110 may transmit, from an upper layer to a lower layer of the first device 110, first information indicating that the message is allowed to be forwarded or second information indicating the resource or resource pool, and transmit, by the lower layer of the first device 110, the message via the resource or resource pool.

In some embodiments, the first device 110 may transmit the message comprising an indication, the indication indicating that the message is allowed to be forwarded. In some embodiments, the indication may comprise the maximum number of hops allowed for the forwarding of the message.

In some embodiments, the first device 110 may transmit the message via an adaptation layer of the first device 110. In some embodiments, the first device 110 may transmit, from an upper layer to a lower layer of the first device, information indicating an identity of a link between the first device 110 and the third device 130, and transmit, by the lower layer of the first device 110, the message via a sidelink SRB over the adaptation layer.

In this way, a source device can indicate whether a message transmitted by the source device is an E2E PC5-S message or a per-hop PC5-S message.

FIG. 5 illustrates an example method 500 of communication implemented at a second device as a relay device in accordance with some embodiments of the present disclosure. For example, the method 500 may be performed at the second device 120 as shown in FIG. 1. It is to be understood that the method 500 may include additional blocks not shown and/or may omit some blocks as shown, and the scope of the present disclosure is not limited in this regard.

At block 510, the second device 120 receives, from the first device 110, a message over a sidelink interface.

At block 520, the second device 120 determines, based on the message, whether the message is allowed to be forwarded via the second device 120. If the message is allowed to be forwarded, the method 500 proceeds to block 530.

In some embodiments, if the message is received via a resource or resource pool configured for indicating that the message is allowed to be forwarded, the second device 120 may determine that the message is allowed to be forwarded. In some embodiments, the resource or resource pool may be associated with at least one of the following: a sidelink SRB, a sidelink RLC channel, a LCH, or a broadcast layer 2 identifier. In some embodiments, the second device 120 may transmit, from a lower layer to an upper layer of the second device 120, third information indicating that the message is allowed to be forwarded or fourth information indicating the resource or resource pool, and determine, by the upper layer of the second device 120, whether the message is allowed to be forwarded.

In some embodiments, if the message comprises an indication indicating that the message is allowed to be forwarded, the second device 120 may determine that the message is allowed to be forwarded.

In some embodiments, if an identity of an adaptation layer in an adaptation layer PDU is different from an identity of an adaptation layer of the second device 120, the second device 120 may determine that the message is allowed to be forwarded.

At block 530, the second device 120 forwards the message to the third device 130. In some embodiments, if the message is allowed to be forwarded, the second device 120 may determine whether the message is to be forwarded. If the message is to be forwarded, the second device 120 may forward the message to the third device 130.

In some embodiments, if the message comprises information of the third device 130 and a link between the second device 120 and the third device 130 has been established, the second device 120 may determine that the message is to be forwarded. In some embodiments, if the second device supports a type of a service comprised in the message, the second device 120 may determine that the message is to be forwarded.

In some embodiments, the second device 120 may forward the message by: modifying the message by the upper layer of the second device 120; updating, with an identity of the first device 110, an identity of a source device in an adaptation layer of the second device 120; and transmitting, by the lower layer of the second device 120, the modified message via the resource or resource pool or a further resource or resource pool configured for indicating that the message is allowed to be forwarded.

In some embodiments, the second device 120 may modify the message by: in accordance with a determination that the second device 120 is the first relay device, modifying the message by adding, as an identity of a relay device, an identity of the second device 120 in the message; and in accordance with a determination that the second device 120 is not the first relay device, replacing, with an identity of the second device 120, an identity of relay device in the message or adding the identity of the second device 120 in a list of identities of delay devices in the message.

In some embodiments, if the identity of the relay device is comprised in the message, the second device 120 may determine that the second device 120 is not the first relay device. In some embodiments, if a value of a counter comprised in the message is smaller than a predetermined value, the second device 120 may determine that the second device 120 is not the first relay device.

In some embodiments, the second device 120 may update the identity of the source device in the adaptation layer of the second device by: reusing the identity of the source device in the adaptation layer of the second device; replacing the identity of the source device with an identity allocated by the second device; or adding an identity allocated by the second device for the adaptation layer.

In some embodiments where the message comprises the indication indicating that the message is allowed to be forwarded and the indication has a value greater than zero, the second device 120 may forward the message by: modifying the message by decreasing the value of the indication; and forwarding the modified message to the third device 130.

In some embodiments where the message is received via an adaptation layer, the second device 120 may forward the message by: transmitting, from an upper layer to a lower layer of the second device 120, information indicating a sidelink SRB; determining, by the lower layer of the second device 120, an egress link based on the sidelink SRB; and forwarding, by the lower layer of the second device 120, the message via the egress link.

In some embodiments where the message is received via an adaptation layer, the second device 120 may forward the message by: transmitting, from an upper layer to a lower layer of the second device 120, information indicating a sidelink SRB and an identity of an adaptation layer of the second device 120; determining, by the lower layer of the second device 120, an egress sidelink RLC channel based on the sidelink SRB and the identity of the adaptation layer of the second device 120 or based on the sidelink SRB; and forwarding, by the lower layer of the second device 120, the message via the egress sidelink RLC channel.

In this way, a relay device can differentiate an E2E PC5-S message from a per-hop PC5-S message.

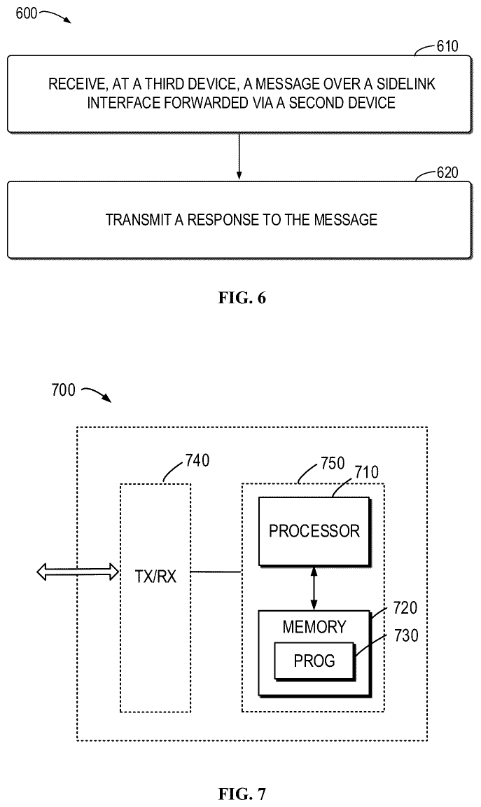

FIG. 6 illustrates an example method 600 of communication implemented at a third device as a destination device in accordance with some embodiments of the present disclosure. For example, the method 600 may be performed at the first device 110 or the third device 130 as shown in FIG. 1. For the purpose of discussion, in the following, the method 600 will be described with reference FIG. 1 and by taking the third device 130 as an example. It is to be understood that the method 600 may include additional blocks not shown and/or may omit some blocks as shown, and the scope of the present disclosure is not limited in this regard.

At block 610, the third device 130 receives a message over a sidelink interface forwarded via the second device 120.

At block 620, the third device 130 transmits a response to the message to indicate that the response is allowed to be forwarded via the second device 120.

In some embodiments, the third device 130 may transmit the response by: transmitting, from a lower layer to an upper layer of the third device 130, fifth information indicating that the message is allowed to be forwarded or sixth information indicating a resource or resource pool, the resource or resource pool being configured for indicating that the message is allowed to be forwarded; transmitting, from the upper layer to the lower layer of the third device 130, seventh information indicating that the response is allowed to be forwarded or eighth information indicating the resource or resource pool; and transmitting, by the lower layer of the third device 130, the response via the resource or resource pool.

In some embodiments, the third device 130 may transmit the response by: transmitting, from a lower layer to an upper layer of the third device 130, ninth information indicating that the message is transmitted via an adaptation layer of the second device 120 or indicating an ID of a link between the first device 110 and the third device 130; transmitting, from the upper layer to the lower layer of the third device 130, tenth information indicating that the response is transmitted via an adaptation layer of the third device 130 or indicating the ID of the link between the first device 110 and the third device 130; and transmitting, by the lower layer of the third device 130, the response via the adaptation layer of the third device 130.

In this way, a destination device can differentiate an E2E PC5-S message from a per-hop PC5-S message and transmit a response accordingly.

### Example Implementation of Device

FIG. 7 is a simplified block diagram of a device 700 that is suitable for implementing embodiments of the present disclosure. The device 700 can be considered as a further example implementation of the first device 110 or the second device 120 or the third device 130 as shown in FIG. 1. Accordingly, the device 700 can be implemented at or as at least a part of the first device 110 or the second device 120 or the third device 130.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a first device comprises a circuitry configured to: determine whether a message over a sidelink interface is allowed to be forwarded via a second device; and in accordance with a determination that the message is allowed to be forwarded, transmit the message to indicate that the message is allowed to be forwarded.

In some embodiments, the circuitry may be configured to transmit the message by transmitting the message via a resource or resource pool configured for indicating that the message is allowed to be forwarded. In some embodiments, the resource or resource pool is associated with at least one of the following: a sidelink signaling radio bearer, a sidelink radio link control channel, a logical channel, a broadcast layer 2 identifier, a sidelink-unlicensed resource pool, or a sidelink resource pool.

In some embodiments, the circuitry may be configured to transmit the message via the resource or resource pool by: transmitting, from an upper layer to a lower layer of the first device, first information indicating that the message is allowed to be forwarded or second information indicating the resource or resource pool; and transmitting, by the lower layer of the first device, the message via the resource or resource pool.

In some embodiments, the circuitry may be configured to transmit the message by: transmitting the message comprising an indication, the indication indicating that the message is allowed to be forwarded. In some embodiments, the indication comprises the maximum number of hops allowed for the forwarding of the message.

In some embodiments, the circuitry may be configured to transmit the message by: transmitting the message via an adaptation layer of the first device. In some embodiments, the circuitry may be configured to transmit the message by: transmitting, from an upper layer to a lower layer of the first device, information indicating an identity of a link between the first device and a third device; and transmitting, by the lower layer of the first device, the message via a sidelink signaling radio bearer over the adaptation layer.

In some embodiments, a second device comprises a circuitry configured to: receive, from a first device, a message over a sidelink interface; determine, based on the message, whether the message is allowed to be forwarded via the second device; and in accordance with a determination that the message is allowed to be forwarded, forward the message to a third device.

In some embodiments, the circuitry may be configured to determine whether the message is allowed to be forwarded by: in accordance with a determination that the message is received via a resource or resource pool configured for indicating that the message is allowed to be forwarded, determining that the message is allowed to be forwarded. In some embodiments, the resource or resource pool is associated with at least one of the following: a sidelink signaling radio bearer, a sidelink radio link control channel, a logical channel, a broadcast layer 2 identifier, a sidelink-unlicensed resource pool, or a sidelink resource pool.

In some embodiments, the circuitry may be configured to determine whether the message is allowed to be forwarded by: transmitting, from a lower layer to an upper layer of the second device, third information indicating that the message is allowed to be forwarded or fourth information indicating the resource or resource pool; and determining, by the upper layer of the second device, whether the message is allowed to be forwarded.

In some embodiments, the circuitry may be configured to forward the message by: in accordance with a determination that the message is allowed to be forwarded, determining whether the message is to be forwarded; and in accordance with a determination that the message is to be forwarded, forwarding the message to the third device.

In some embodiments, the circuitry may be configured to determine whether the message is to be forwarded by: in accordance with a determination that the message comprises information of the third device and a link between the second device and the third device has been established, determining that the message is to be forwarded; or in accordance with a determination that the second device supports a type of a service comprised in the message, determining that the message is to be forwarded.

In some embodiments, the circuitry may be configured to forward the message by: modifying the message by the upper layer of the second device; updating, with an identity of the first device, an identity of a source device in an adaptation layer of the second device; and transmitting, by the lower layer of the second device, the modified message via the resource or resource pool or a further resource or resource pool configured for indicating that the message is allowed to be forwarded.

In some embodiments, the circuitry may be configured to modify the message by: in accordance with a determination that the second device is the first relay device, modifying the message by adding, as an identity of a relay device, an identity of the second device in the message; and in accordance with a determination that the second device is not the first relay device, replacing, with an identity of the second device, an identity of relay device in the message or adding the identity of the second device in a list of identities of delay devices in the message.

In some embodiments, the circuitry may be further configured to: in accordance with a determination that the identity of the relay device is comprised in the message, determine that the second device is not the first relay device; or in accordance with a determination that a value of a counter comprised in the message is smaller than a predetermined value, determine that the second device is not the first relay device.

In some embodiments, the circuitry may be configured to update the identity of the source device in the adaptation layer of the second device by: reusing the identity of the source device in the adaptation layer of the second device; replacing the identity of the source device with an identity allocated by the second device; or adding an identity allocated by the second device for the adaptation layer.

In some embodiments, the circuitry may be configured to determine whether the message is allowed to be forwarded by: in accordance with a determination that the message comprises an indication indicating that the message is allowed to be forwarded, determining that the message is allowed to be forwarded. In some embodiments where the indication has a value greater than zero, the circuitry may be configured to forward the message by: modifying the message by decreasing the value of the indication; and forwarding the modified message to the third device.

In some embodiments, the circuitry may be configured to determine whether the message is allowed to be forwarded by: in accordance with a determination that an identity of an adaptation layer in an adaptation layer protocol data unit is different from an identity of an adaptation layer of the second device, determining that the message is allowed to be forwarded.

In some embodiments, the circuitry may be configured to forward the message by: transmitting, from an upper layer to a lower layer of the second device, information indicating a sidelink signaling radio bearer; determining, by the lower layer of the second device, an egress link based on the sidelink signaling radio bearer; and forwarding, by the lower layer of the second device, the message via the egress link.

In some embodiments, the circuitry may be configured to forward the message by: transmitting, from an upper layer to a lower layer of the second device, information indicating a sidelink signaling radio bearer and an identity of an adaptation layer of the second device; determining, by the lower layer of the second device, an egress sidelink radio link control channel based on the sidelink signaling radio bearer and the identity of the adaptation layer of the second device or based on the sidelink signaling radio bearer; and forwarding, by the lower layer of the second device, the message via the egress sidelink radio link control channel.

In some embodiments, a third device comprises a circuitry configured to: receive a message over a sidelink interface forwarded via a second device; and transmit a response to the message to indicate that the response is allowed to be forwarded via the second device.

In some embodiments, the circuitry may be configured to transmit the response by: transmitting, from a lower layer to an upper layer of the third device, fifth information indicating that the message is allowed to be forwarded or sixth information indicating a resource or resource pool, the resource or resource pool being configured for indicating that the message is allowed to be forwarded; transmitting, from the upper layer to the lower layer of the third device, seventh information indicating that the response is allowed to be forwarded or eighth information indicating the resource or resource pool; and transmitting, by the lower layer of the third device, the response via the resource or resource pool.

In some embodiments, the circuitry may be configured to transmit the response by: transmitting, from a lower layer to an upper layer of the third device, ninth information indicating that the message is transmitted via an adaptation layer of the second device or indicating an identity of a link between the first device and the third device; transmitting, from the upper layer to the lower layer of the third device, tenth information indicating that the response is transmitted via an adaptation layer of the third device or indicating the identity of the link between the first device and the third device; and transmitting, by the lower layer of the third device, the response via the adaptation layer of the third device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a first device, whether a message over a sidelink interface is allowed to be forwarded via a second device; and
in accordance with a determination that the message is allowed to be forwarded, transmitting the message to indicate that the message is allowed to be forwarded.

2. The method of claim 1, wherein transmitting the message comprises:
transmitting the message via a resource or resource pool configured for indicating that the message is allowed to be forwarded.

3. The method of claim 2, wherein the resource or resource pool is associated with at least one of the following: a sidelink signaling radio bearer, a sidelink radio link control channel, a logical channel, a broadcast layer 2 identifier, a sidelink-unlicensed resource pool, or a sidelink resource pool.

4. The method of claim 2, wherein transmitting the message via the resource or resource pool comprises:
transmitting, from an upper layer to a lower layer of the first device, first information indicating that the message is allowed to be forwarded or second information indicating the resource or resource pool; and
transmitting, by the lower layer of the first device, the message via the resource or resource pool.

5. The method of claim 1, wherein transmitting the message comprises:
transmitting the message comprising an indication, the indication indicating that the message is allowed to be forwarded.

6. The method of claim 5, wherein the indication comprises the maximum number of hops allowed for the forwarding of the message.

7. The method of claim 1, wherein transmitting the message comprises:
transmitting the message via an adaptation layer of the first device.

8. The method of claim 7, wherein transmitting the message comprises:
transmitting, from an upper layer to a lower layer of the first device, information indicating an identity of a link between the first device and a third device; and
transmitting, by the lower layer of the first device, the message via a sidelink signaling radio bearer over the adaptation layer.

9. A method of communication, comprising:
receiving, at a second device and from a first device, a message over a sidelink interface;
determining, based on the message, whether the message is allowed to be forwarded via the second device; and
in accordance with a determination that the message is allowed to be forwarded, forwarding the message to a third device.

10. The method of claim 9, wherein determining whether the message is allowed to be forwarded comprises:
in accordance with a determination that the message is received via a resource or resource pool configured for indicating that the message is allowed to be forwarded, determining that the message is allowed to be forwarded.

11. The method of claim 10, wherein the resource or resource pool is associated with at least one of the following: a sidelink signaling radio bearer, a sidelink radio link control channel, a logical channel, a broadcast layer 2 identifier, a sidelink-unlicensed resource pool, or a sidelink resource pool.

12. The method of claim 10, wherein determining whether the message is allowed to be forwarded comprises:
transmitting, from a lower layer to an upper layer of the second device, third information indicating that the message is allowed to be forwarded or fourth information indicating the resource or resource pool; and
determining, by the upper layer of the second device, whether the message is allowed to be forwarded.

13. The method of claim 9, wherein forwarding the message comprises:
in accordance with a determination that the message is allowed to be forwarded, determining whether the message is to be forwarded; and
in accordance with a determination that the message is to be forwarded, forwarding the message to the third device.

14. The method of claim 13, wherein determining whether the message is to be forwarded comprises:
in accordance with a determination that the message comprises information of the third device and a link between the second device and the third device has been established, determining that the message is to be forwarded; or
in accordance with a determination that the second device supports a type of a service comprised in the message, determining that the message is to be forwarded.

15. The method of claim 9 or 13, wherein forwarding the message comprises:
modifying the message by the upper layer of the second device;
updating, with an identity of the first device, an identity of a source device in an adaptation layer of the second device; and
transmitting, by the lower layer of the second device, the modified message via the resource or resource pool or a further resource or resource pool configured for indicating that the message is allowed to be forwarded.

16. The method of claim 15, wherein modifying the message comprises:
in accordance with a determination that the second device is the first relay device, modifying the message by adding, as an identity of a relay device, an identity of the second device in the message; and
in accordance with a determination that the second device is not the first relay device, replacing, with an identity of the second device, an identity of relay device in the message or adding the identity of the second device in a list of identities of delay devices in the message.

17. The method of claim 16, further comprising:
in accordance with a determination that the identity of the relay device is comprised in the message, determining that the second device is not the first relay device; or
in accordance with a determination that a value of a counter comprised in the message is smaller than a predetermined value, determining that the second device is not the first relay device.

18. The method of claim 15, wherein updating the identity of the source device in the adaptation layer of the second device comprises:
reusing the identity of the source device in the adaptation layer of the second device;
replacing the identity of the source device with an identity allocated by the second device; or
adding an identity allocated by the second device for the adaptation layer.

19. The method of claim 9, wherein determining whether the message is allowed to be forwarded comprises:
in accordance with a determination that the message comprises an indication indicating that the message is allowed to be forwarded, determining that the message is allowed to be forwarded.

20. The method of claim 19, wherein the indication has a value greater than zero, and wherein forwarding the message comprises:
modifying the message by decreasing the value of the indication; and
forwarding the modified message to the third device.

21. The method of claim 9, wherein determining whether the message is allowed to be forwarded comprises:
in accordance with a determination that an identity of an adaptation layer in an adaptation layer protocol data unit is different from an identity of an adaptation layer of the second device, determining that the message is allowed to be forwarded.

22. The method of claim 9, wherein forwarding the message comprises:
transmitting, from an upper layer to a lower layer of the second device, information indicating a sidelink signaling radio bearer;
determining, by the lower layer of the second device, an egress link based on the sidelink signaling radio bearer; and
forwarding, by the lower layer of the second device, the message via the egress link.

23. The method of claim 9, wherein forwarding the message comprises:
transmitting, from an upper layer to a lower layer of the second device, information indicating a sidelink signaling radio bearer and an identity of an adaptation layer of the second device;
determining, by the lower layer of the second device, an egress sidelink radio link control channel based on the sidelink signaling radio bearer and the identity of the adaptation layer of the second device or based on the sidelink signaling radio bearer; and
forwarding, by the lower layer of the second device, the message via the egress sidelink radio link control channel.

24. A method of communication, comprising:
receiving, at a third device, a message over a sidelink interface forwarded via a second device; and
transmitting a response to the message to indicate that the response is allowed to be forwarded via the second device.

25. The method of claim 24, wherein transmitting the response comprises:
transmitting, from a lower layer to an upper layer of the third device, fifth information indicating that the message is allowed to be forwarded or sixth information indicating a resource or resource pool, the resource or resource pool being configured for indicating that the message is allowed to be forwarded;
transmitting, from the upper layer to the lower layer of the third device, seventh information indicating that the response is allowed to be forwarded or eighth information indicating the resource or resource pool; and
transmitting, by the lower layer of the third device, the response via the resource or resource pool.

26. The method of claim 24, wherein transmitting the response comprises:
transmitting, from a lower layer to an upper layer of the third device, ninth information indicating that the message is transmitted via an adaptation layer or indicating an identity of a link between the first device and the third device;
transmitting, from the upper layer to the lower layer of the third device, tenth information indicating that the response is transmitted via an adaptation layer of the third device or indicating the identity of the link between the first device and the third device; and
transmitting, by the lower layer of the third device, the response via the adaptation layer of the third device.

27. A terminal device comprising:
a processor configured to perform the method according to any of claims 1 to 8 or any of claims 9 to 23 or any of claims 24 to 26.
